(19) United States
(12) Patent Application Publication
(10) Pub. No.: US 2011/0113475 A1
(43) Pub. Date: May 12, 2011

(54) NODE FOR A NETWORK AND METHOD FOR ESTABLISHING A DISTRIBUTED SECURITY ARCHITECTURE FOR A NETWORK

(75) Inventors: Oscar Garcia Morchon, Aachen (DE); Bozena Erdmann, Aachen (DE); Axel Guenther Huebner, Muenchen (DE); Heribert Baldus, Aachen (DE)

(73) Assignee: KONINKLIJKE PHILIPS ELECTRONICS N.V., EINDHOVEN (NL)

(21) Appl. No.: 12/674,950

(22) PCT Filed: Sep. 4, 2008
(86) PCT No.: PCT/IB08/53579

§ 371 Date: Feb. 24, 2010

(30) Foreign Application Priority Data
Sep. 7, 2007 (EP) 07115918.0

(51) Int. Cl. G06F 17/30

(52) U.S. Cl. 726/4

(57) ABSTRACT

The invention relates to a node (100) for a network such as a wireless control network or the like. In this network, each node (100) comprises a identifier (104) and keying material (102), means for authenticating (112) the node's identifier based on the node's keying material and means for checking (114) the access control rights of the node in a distributed manner based on the node's multidimensional identity and access rights corresponding to the node's identity. Additionally, the invention allows the node to generate a common key with any other node in the first keying first network that can be used to enable further material identifier secure communications.

The invention relates in general to a node for a network, to a network and to a method for establishing a security architecture for a network, particularly including key agreement, identity authentication and distributed access control.

Pervasive computing is going to enable the creation of smart environments (SEs) in which sensors, actuators, displays, and computational elements will be embedded seamlessly in everyday objects. Such smart environments will make human interaction with such systems a pleasant experience.

Smart environments face up to new security threats making fundamental the definition of a consistent and practical security architecture (SA) for smart environments. The security architecture has to guarantee basic security services, such as authentication and access control. On the one hand, authentication must ensure that intruders cannot interact with the smart environment, e.g. by sending false commands. On the other hand, access control must guarantee that authenticated users perform according to predefined access rights. The state-of-the-art, for example ZigBee® lacks of an efficient security architecture. As described by Cook, Diane; Sajal Das (2004); Smart Environments Technology, Protocols and Applications; Wiley-Interscience, ZigBee® lacks an efficient and practical security architecture as the participation of an online trust center (OTC) is required during the authentication process. This requirement has several drawbacks, as resources around the online trust center may be overloaded and a single point of failure is presented. Additionally, ZigBee® does not define efficient access control procedures.

US2007/0078817 A1 is directed to a method for distributing keys in a sensor node network. Initially, sensor nodes store a subset of keys from a set of keys. A sink node triggers a key election procedure and sensor nodes choose from a locally broadcasted key-ID list one key to be stored on each sensor node. All other initially stored keys are subsequently deleted.

It is an object of the present invention to provide an improved node for a network, an improved network and an improved method for establishing a security architecture for a network.

The object is solved by the independent claims. Further embodiments are shown by the dependent claims.

A basic idea of the invention is the definition of a new practical and efficient security architecture wherein authentication and authorization processes can be carried out in an ad hoc manner. Thus, an online trust center is only required during a setup phase. In this manner, a security architecture according to the inventive approach has low communication overhead, avoids single points of failure and makes security transparent for users.

A key problem of any type of smart environment or in general of any type of complex control network is to control it in an efficient and secure manner. In this context, smart environments, in general, and lighting smart environments, in particular, can be deployed if basic security issues are solved. Because of the expected mobility of control nodes or other nodes and the expected flexibility of smart environments, which must accommodate for system re-configurations, the security systems for smart environments must be flexible and scalable as well. On the one hand, lighting smart environments must be able to authenticate each and every node in the network. For instance, if authentication is not ensured, malicious nodes or intruders might inject false messages that could switch off a whole lighting system, like a building lighting smart environment. On the other hand, lighting smart environments must be able to control access rights to the system, i.e., authorization rights, as users might have different access rights depending on, e.g., their location or status. The provision of above-described security services requires the definition of a specific key distribution architecture (KDA) for lighting smart environments. The key distribution architecture is the security keystone as it distributes the cryptographic keys that enable further security services.

The definition of a security architecture for lighting smart environments, including the key distribution architecture, authentication and access control services, is challenging due to technical restrictions and operational requirements. On the one hand, lighting smart environment are composed of wireless lighting nodes and actuators with minimal resources from computational, communicational, energy, and memory points of view. On the other hand, lighting smart environments are large scalable mobile ad hoc networks.

Those technical restrictions and operational requirements make the use of current solutions impossible and demand a security architecture with novel features. Firstly, the lighting smart environment key distribution architecture cannot be based on traditional approaches such as public key due to the high computational requirements.

Likewise, centralized solutions based on a trust centre are not possible due to the ad hoc nature of lighting smart environments. In general, a lighting smart environment key distribution architecture must work without requiring access to a trust centre and be feasible in mobile scenarios. Additionally, the key distribution architecture must have minimal resource requirements. Secondly, the authentication procedure must not rely on third parties. Finally, typical access control approaches based on an access control list (ACL) are not possible due to the high scalability of lighting smart environments and the low memory capacity of lighting smart environment nodes that makes impossible the access control list storage. Therefore, new access control approaches must be developed to make the implementation of access control services possible with minimal requirements.

ZigBee® 's security architecture is not flexible enough as it relies on a centralized online trust center and does not describe any kind of access control mechanisms. Therefore, the ZigBee® commercial building automation profile specification should be extended with flexible security architecture and access control mechanisms, in order to allow future smart lighting applications, like smart lighting applications.

The inventive approach addresses all beforehand mentioned problems by describing a lighting smart environment security architecture feasible and practical for smart environments that enables effortless implementation of authentication and access control security services in these networks.

The inventive security architecture may be used in a lighting smart environment. An advantage of the inventive security architecture is its minimal resource requirement. Thus, it is a feasible security architecture for resource-constrained lighting smart environment nodes. An operation of the security architecture may be fully distributed. The distributed operation matches with the operational requirements, like mobility or ad hoc operation of lighting smart environments. Further, the security architecture allows an effortless implementation of authentication services and a trouble-free implementation of access control services, as the security architecture maps an existing relationship between nodes. The security architecture allows two nodes to agree on a common secret with a high security level based on some pre-distributed keying material and can be applied to other types of smart environments or control networks. A further advantage of the inventive security architecture is that its application area and technological solution may be used to add to the ZigBee® standard, e.g., by incorporating it to the ZigBee®'s Application Profile “Commercial Building Automation”; ZigBee Document 053515r07, “Commercial Building Automation—Profile Specification” February 2007.

According to an embodiment of the invention, a node for a network is provided, comprising:
a first identifier and first keying material;
means for authenticating the first identifier based on the first keying material; and
means for checking the access control rights of the node based on the first identifier and access rights corresponding to the first identifier in a distributed way.

The node may comprise means for agreeing on a common secret between the node and a further node of the network, wherein the means for agreeing may be configured to agree on the common secret based on the first identifier and the first keying material of the node and a second keying material and a second identifier of the further node. This allows any two nodes of the network to agree on a common secret based on the keying material they carry and their identifiers.

The means for agreeing may be configured to agree on the common secret based on a λ-secure establishing method. Examples of λ-secure key establishment methods are R. Blom, “An Optimal Class of Symmetric Key Generation Systems” Advances in Cryptology: Proc. Eurocrypt'84, pp. 335-338, 1984 and C. Blundo, A. D. Santis, A. Herzberg, S. Kutten, U. Vaccaro and M. Yung, “Perfectly-Secure Key Distribution for Dynamic Conferences”, Proc. Conf. Advances in Cryptology (Crypto'92), E. F. Brickell, ed., pp. 471-486, 1992. λ-secure key establishment methods guarantee that the coalition of at most λ nodes does not compromise the security of the system, i.e., an attacker must collect more than λ sets of keying material to crack the system.

A role based access control solution may be implemented by dividing the identifier space of the λ-secure key establishment method into several identifier sub-spaces, wherein each of these identifier sub-spaces is linked to a different role. In this manner, the role of a node can be identified easily by identifying the identifier sub-space which the nodes identifier belongs to. Relying on a centralized infrastructure for access control leads to increased delays and intensive traffic

Further, the means for authenticating may be configured to use the common secret for authenticating the first identifier.

According to an embodiment, the node may comprise a plurality of features and each feature may comprise a plurality of hierarchical levels, and wherein the first identifier may comprise a plurality of first sub-identifiers, wherein each hierarchical level of each feature may be linked to a different one of the plurality of first sub-identifiers. This allows defining a node as a collection of features which can be described with an increasing degree of accuracy.

Further, the first keying material may comprise a plurality of sets of first keying material, wherein each sub-identifier is linked to a different one of the plurality of sets of first keying material. The sets of keying material allow an authentication of the sub-identifiers.

The means for authenticating may be configured to authenticate a particular first sub-identifier based on the set of first keying material linked to the particular first sub-identifier. This allows an independent authentication of each sub-identifier.

The means for authenticating may further be configured to authenticate, additional to the particular first sub-identifier, all sub-identifiers being linked to a lower hierarchical level of the same feature the particular first sub-identifier is linked to.

The means for checking may be configured to check the authorization of the node based on the successful authentication of a set of first sub-identifiers and access rights corresponding to the set of first sub-identifiers. Thus, the node may be authorized for a particular access without having to reveal its whole identity.

According to an embodiment, the means for agreeing may be configured to agree on a common sub-secret for a particular sub-identifier based on the set of first keying material linked to the particular sub-identifier and a set of second keying material linked to a second sub-identifier of the further node. This allows using the sets of keying material for determining common sub-secrets.

The means for agreeing may be configured to generate a first partial key for the particular sub-identifier and to receive the second sub-identifier and a second partial key from the further node, for agreeing on the common sub-secret for the particular sub-identifier.

The means for agreeing may further be configured to agree on a plurality of common sub-secret for a plurality of sub-identifiers and to determine a common secret based on the plurality of common sub-secrets. This allows a pair of nodes of the network to agree on a main key with a high security level.

The means for agreeing may be configured to determine the common secret by performing an XOR combination of the plurality of common sub-secrets.

According to an embodiment, the node may be a lighting node of the network comprising a set of operation rules specifying access rights being required by the further node to carry out a specific action.

The node might also be a medical node used in other wireless sensor network applications such as patient monitoring.

Alternatively, the node may be a control node of the network.

According to a further embodiment of the invention, a network is provided, comprising:
at least one first node according to an embodiment of the invention; and
at least one second node according to an embodiment of the invention.

According to a further embodiment of the invention, a method for establishing a security architecture for a network is provided, comprising the steps of:
providing an identifier and keying material to a node of the network;
authenticating the identifier based on the keying material; and
checking the access control rights of the node in a distributed manner based on the identifier and access rights corresponding to the identifier.

According to a further embodiment of the invention, a computer program may be provided, which is enabled to carry out the above method according to the invention when executed by a computer, sensor node or the like. This allows realizing the inventive approach in a compiler program.

According to a further embodiment of the invention, a record carrier storing a computer program according to the invention may be provided, for example a CD-ROM, a DVD, a memory card, a diskette, or a similar data carrier suitable to store the computer program for electronic access.

These and other aspects of the invention will be apparent from and elucidated with reference to the embodiments described hereinafter.

The invention will be described in more detail hereinafter with reference to exemplary embodiments. However, the invention is not limited to these exemplary embodiments.

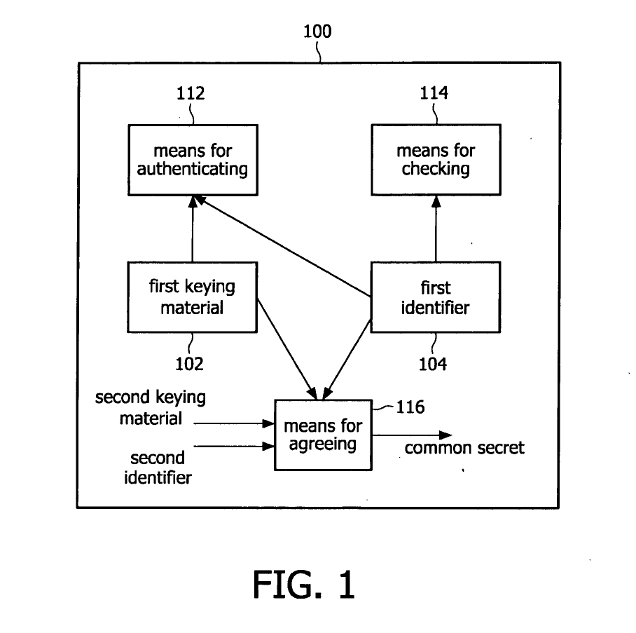

FIG. 1 shows a node for a network according to the invention;

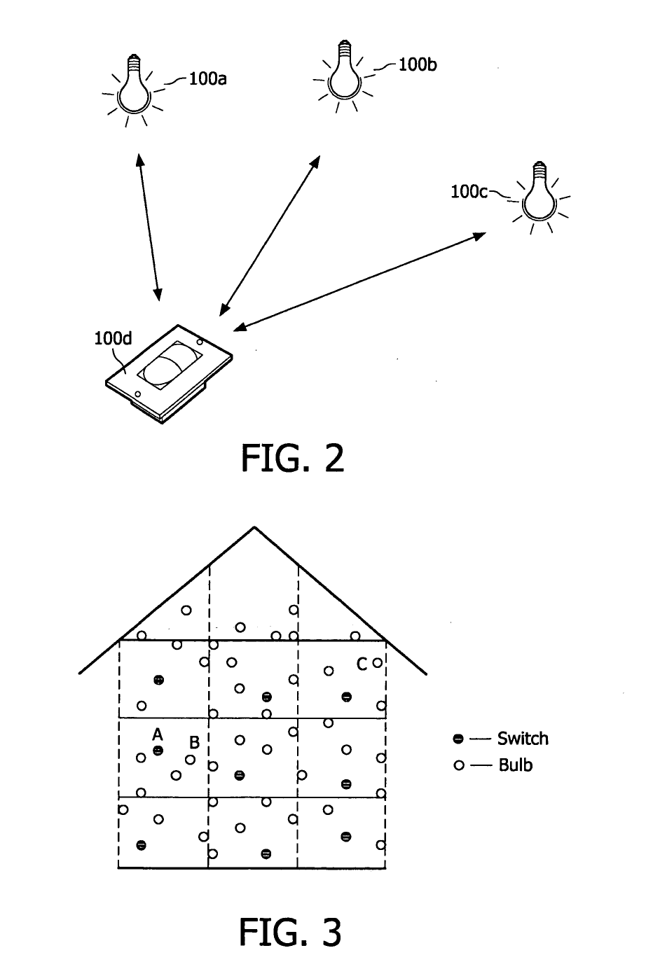

FIG. 2 shows a light smart environment according to the invention;

FIG. 3 shows a building light smart environment according to the invention;

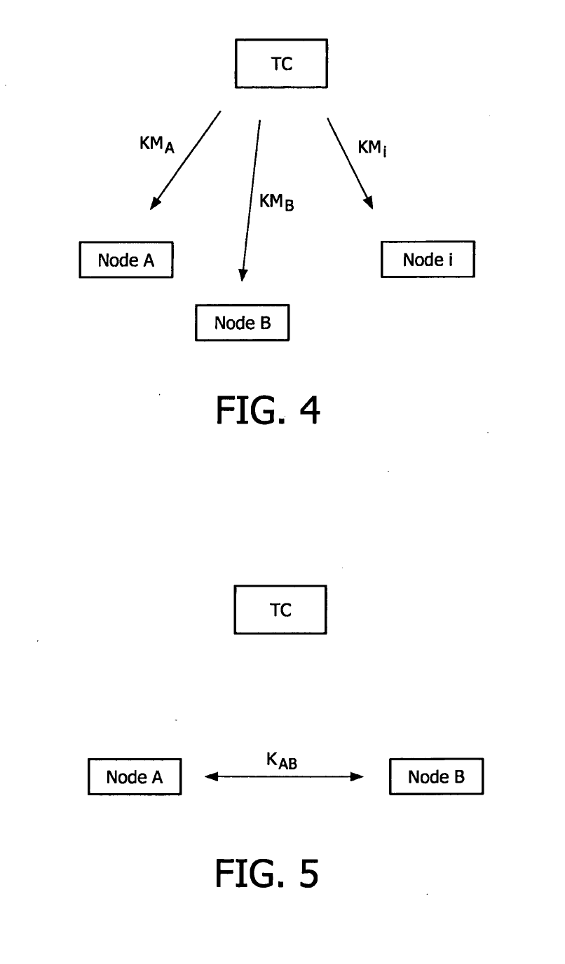

FIG. 4 shows a setup phase of a key establishment method according to the invention;

FIG. 5 shows an operational phase of key establishment method according to the invention;

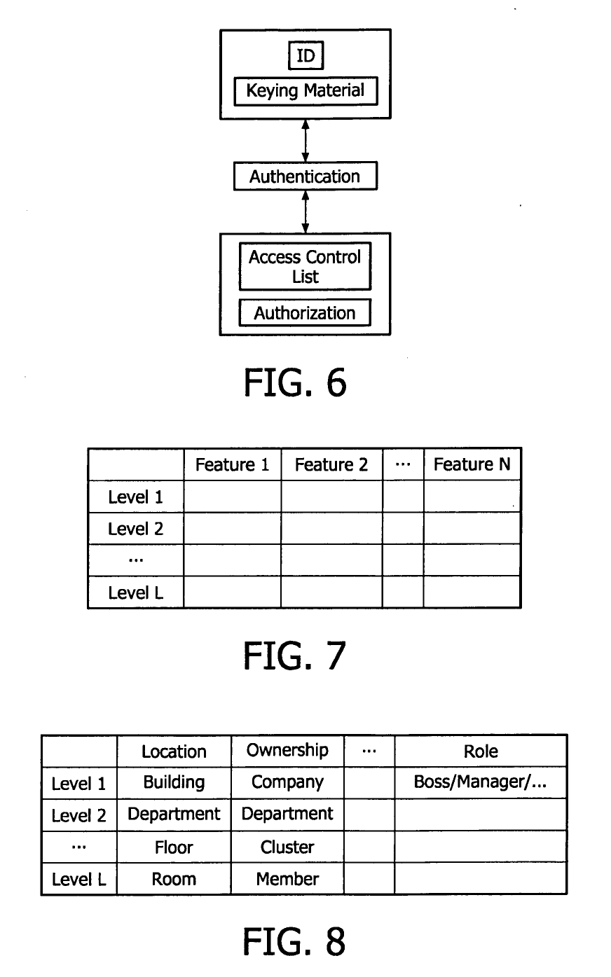

FIG. 6 shows a key delivery architecture according to the invention;

FIG. 7 shows a multidimensional identity of a node according to the invention;

FIG. 8 shows a further multidimensional identity of a node according to the invention;

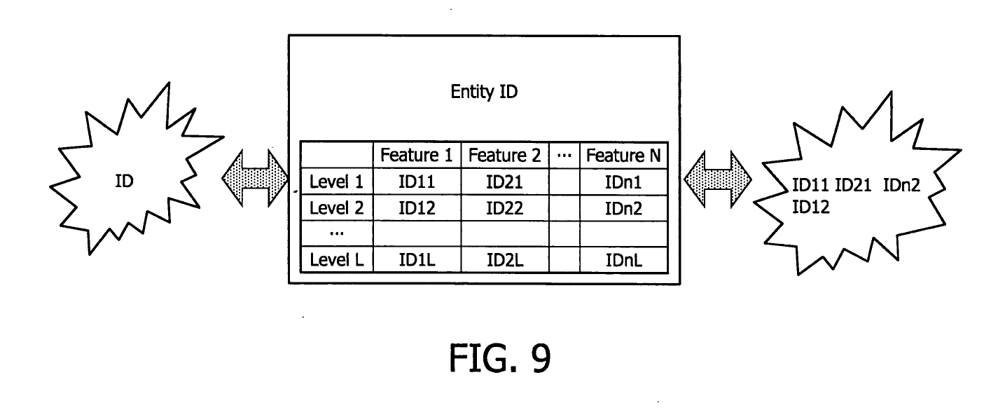

FIG. 9 shows identification models according to the invention;

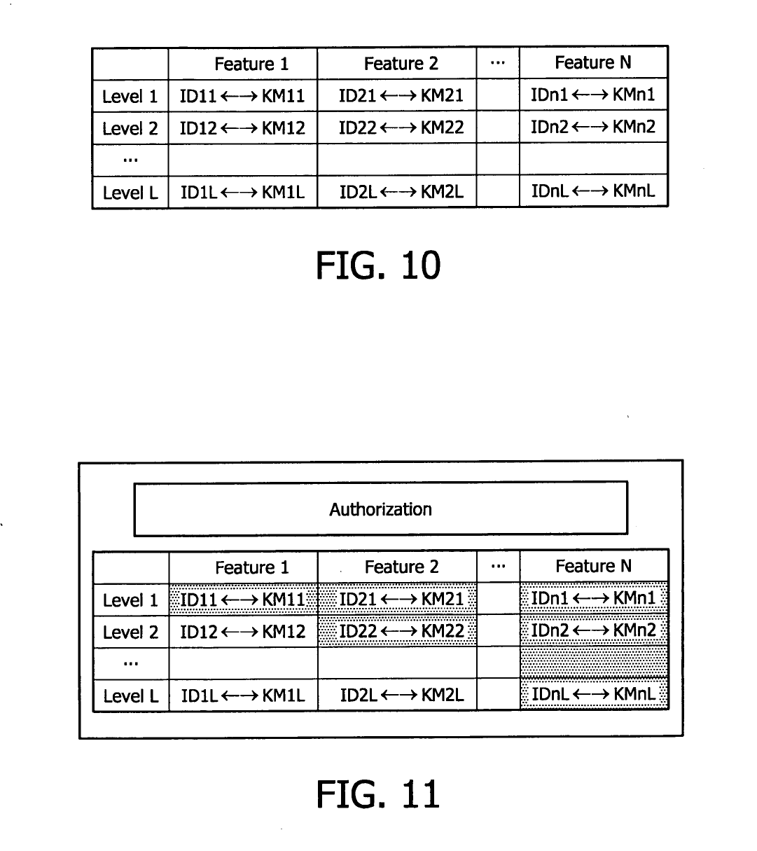

FIG. 10 shows a multidimensional authentication according to the invention;

FIG. 11 shows a further multidimensional authentication according to the invention;

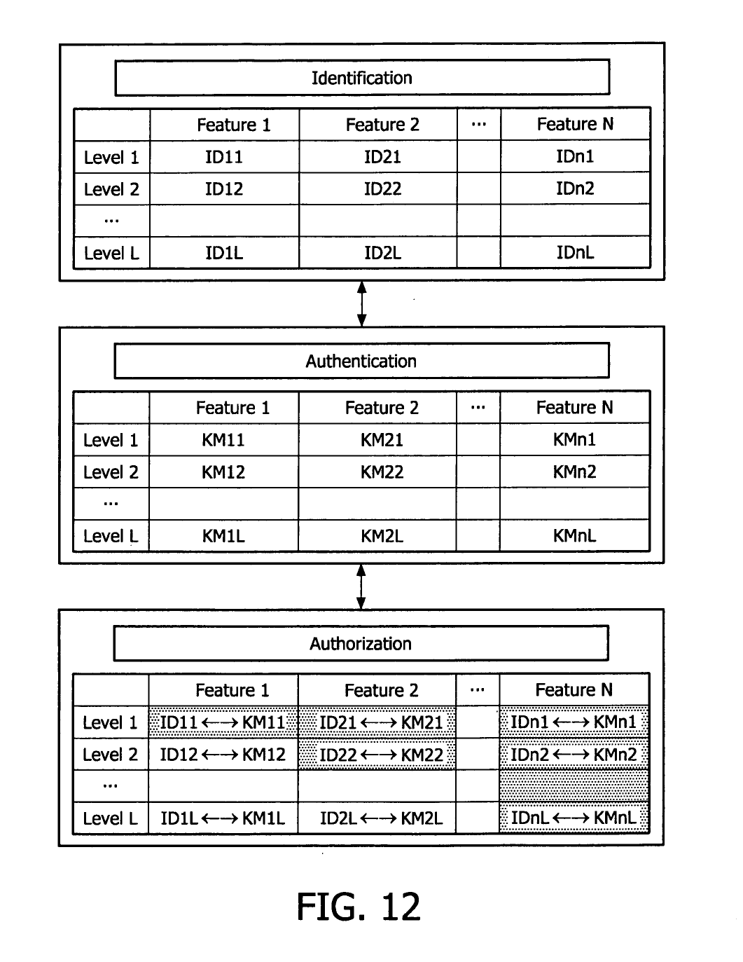

FIG. 12 shows an overview of a key delivery architecture according to the invention; and

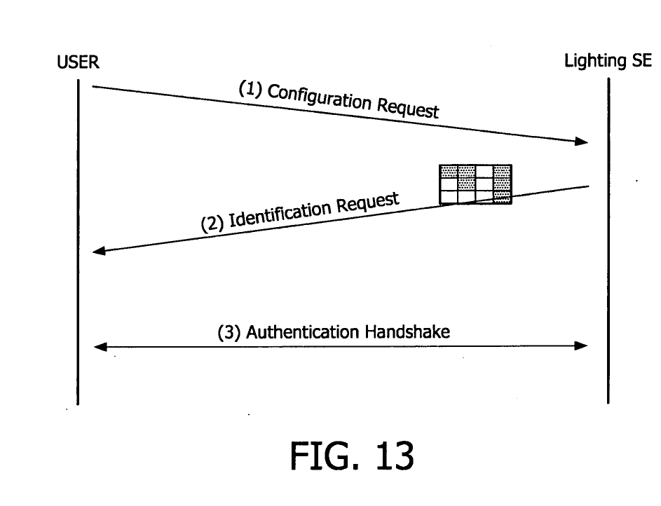

FIG. 13 shows an operation of a security architecture according to the invention.

In the following, functional similar or identical elements may have the same reference numerals.

FIG. 1 shows a node 100 for a network according to an embodiment of the invention. The node 100 may be a device or entity of the network. For example, the node may be a lighting node or a control node of the network. The node 100 comprises a first identifier 104 and first keying material 102. The identifier 104 and the first keying material 102 may be stored in a memory of the node 100. The node 100 further comprises means for authenticating 112 the first identifier 104 and means for checking 114 an authorization of the node 100. The means for authenticating 112 may be configured to authenticate the first identifier 104 based on the first keying material 102. Thus, the means for authenticating may be configured to read the first identifier 104 and the first keying material 102 and to provide an authentication result which indicates if the first identifier 104 was correctly identified. The means for checking 114 may be configured to check the authorization of the node 100 based on the first identifier 104 and on additional access rights which correspond to the first identifier 104. Thus, the means for checking 114 may be configured to read the first identifier 104 and the additional access rights and provide a checking result which indicates if the node 100 is authorized, for example to carry out a certain operation.

The node 100 may further comprise means for agreeing 116 on a common secret between the node 100 and a further node of the network. The further node may be equal or similar to the node 100. The means for agreeing 116 may be configured to receive the first identifier 104, the first keying material 102 and, from the further node, a second identifier and a second keying material. The means for agreeing 116 may be configured to agree on the common secret based on the first identifier 104, the first keying material 102, the second keying material and the second identifier. A λ-secure establishing method may be used to agree on the common secret. The means for agreeing 116 may be configured to provide the common secret. The common secret may be used by the means for authenticating 112 to authenticate the first identifier 104.

According to an embodiment, the node 100 comprises a plurality of features. Each feature may be divided into a plurality of hierarchical levels, as shown in FIG. 8. For identifying each hierarchical level of each feature, the first identifier 104 may comprise a plurality of first sub-identifiers as shown in FIG. 9. Thus, each hierarchical level of each feature can be linked to a different one of the plurality of first sub-identifiers. Similar to the first identifier 104, the first keying material 102 may comprise a plurality of sets of first keying material. As shown in FIG. 10, each sub-identifier can be linked to a different one of the plurality of sets of first keying material.

The sets of first keying materials may be used to authenticate the sub-identifiers. In particular, the means for authenticating 112 may be configured to authenticate a particular first sub-identifier based on the set of first keying material linked to the particular first sub-identifier. When authenticating a particular first sub-identifier, the means for authenticating 112 may be configured to authenticate any sub-identifier being linked to a lower hierarchical level of the same feature the particular first sub-identifier is linked to, too.

According to an embodiment, the means for checking 114 may be configured to check a particular authorization of the node 100 based on a set of first sub-identifiers and access rights corresponding to the set of first sub-identifiers. A selection of first sub-identifiers which form the set of first sub-identifiers may, for example, dependent on the kind of desired operation to be carried out by the node 100.

According to an embodiment, the means for agreeing 116 may be configured to agree on common sub-secrets between the node 100 and the further node. The sub-secrets may be related to particular sub-identifiers. The means for agreeing 116 may be configured to agree on a common sub-secret for a particular sub-identifier based on the set of first keying material linked to the particular sub-identifier and a set of second keying material linked to a second sub-identifier of the further node. Further, the means for agreeing 116 may be configured to generate first partial keys for each sub-identifier and to agree on the common sub-secrets based on the first partial keys and second partial keys from the further node. Therefore, the means for agreeing 116 may be configured to receive the second sub-identifier and a second partial key from the further node. Further, the means for agreeing 116 may be configured to agree on a plurality of common sub-secret for a plurality of sub-identifiers of the node 100 and to determine the common secret based on the plurality of common sub-secrets. The common secret may be determined by performing an XOR combination of the plurality of common sub-secrets.

The network, the node 100 is connected to, may perform a method for establishing a security architecture, according to a further embodiment of the invention. In a first step of the method for establishing, the first identifier 104 and the first keying material 102 is provided to the node 100. In a second step, the first identifier 104 is authenticated based on the first keying material 102. In a third step an authorization of the node 100 is checked, based on the first identifier 104 and access rights corresponding to the identifier 104. Further method steps may be performed in order to agree on a common secret or to adapt the method to a node 100 comprising a plurality of sub-identifiers and sets of keying material.

FIG. 2 shows a network according to an embodiment of the invention. The network may comprise a plurality of nodes, like the node 100 shown in FIG. 1. According to this embodiment, the network may be a control network and in particular a light smart environment comprising a first wireless lighting system 100a, a second wireless lighting system 100b, a third wireless lighting system 100c and a wireless switch 100d. The wireless lighting systems 100a, 100b, 100c and the wireless switch 100d may be nodes as shown in FIG. 1. The wireless switch 100d may be configured to switch the wireless lighting systems 100a, 100b, 100c on or off.

A lighting smart environment as shown in FIG. 2 is a smart environment in which lighting control systems are intelligent, wherein e.g. numerous lighting nodes 100a, 100b, 100c are wirelessly controlled by user-carried tokens 100d in an intelligent manner, enabling the automatic configuration and operation of the system according to the user's preferences. FIG. 2 depicts a simple lighting smart environment in which the wireless token 100d wirelessly controls the several wireless lighting systems 100a, 100b, 100c.

FIG. 3 shows a network and in particular a building lighting smart environment according to an embodiment of the invention. The building lighting smart environment comprises a plurality of nodes in the form of switches and bulbs which are arranged in a building. Switches and bulbs may be spread over different rooms and floors of the building.

Real lighting smart environments may be composed of hundreds of wireless lighting nodes, deployed in buildings, streets or everywhere and allow controlling lighting features, such as light colour temperature, intensity, directivity, beam width. In this context, a building lighting smart environment as shown in FIG. 3 with wireless lighting nodes can be imagined. The system operation may be controlled by users that carry wireless control tokens identifying them and their preferences. Thus, applications such as a dynamic lighting adjustment according to the user's preferences can be realized.

Related standards, such as ZigBee®, cover applications similar to smart environments, like smart lighting environments. More specifically, they address profile specifications for building automation in which different applications, like generic, lighting, closures, HVAC and intruder alarm systems can be controlled. These applications are rather primitive as they do not provide the flexibility of smart environments. However, the inventive approach allows appropriate extensions in the standard which can enable the creation of smart environments according to the present invention.

FIGS. 4 and 5 show phases of a λ-secure key establishment method which may be used for a network according to an embodiment of the invention. FIG. 4 shows a setup phase and FIG. 5 shows an operational phase of the key establishment method. The network may comprise a plurality of nodes A, B, i which may be nodes as shown in FIG. 1 and a trust center TC.

Known key distribution approaches based on, e.g., a public key may not be applied to lighting smart environment due to technical restrictions and operational requirements. Due to similar reasons, known access control solutions may be unfeasible in resource constrained nodes as they require the storage of large ACLs and/or runtime access to a security infrastructure, like a centralized security infrastructure. According to embodiments of the invention λ-secure key establishment methods are used to solve both previous problems.

A λ-secure key establishment method (AKEM) according to the invention may be defined as a key establishment approach in which any pair of nodes may agree on a cryptographic secret in an ad hoc manner. In general, during a setup phase as shown in FIG. 4 the trust centre TC distributes a set of keying material KM together with a unique identifier to every node in the network. A set of keying material KM_{A} is distributed to Node A, a further set of keying material KM_{B} is distributed to Node B and a set of keying material KM_{C} is distributed to Node C. After node deployment, as shown in FIG. 5, a pair of nodes A, B exploits the pre-distributed keying material KM_{A}, KM_{B} to agree on a common secret K_{AB}. Future communications between the nodes A, B will be secured based on the common secret K_{AB} or its derivatives. Thus, the common secret K_{AB} may be used for example for confidentiality, authentication or authorization.

λ-secure key establishment methods guarantee that the coalition of at most λ does not compromise the security of the system. Thus, an attacker has to collect more than λ sets of keying material KM to crack the system.

FIG. 6 shows a basic security architecture for a lighting smart environment according to an embodiment of the invention. The basic security architecture is based on a single λ-secure key establishment method. This approach can be used to create a security architecture for lighting smart environments in a simple manner. As shown in FIG. 5 and the top of FIG. 6, the security architecture allows any pair of nodes to agree on a common secret based on the keying material the nodes carry and the identifier of the nodes. Consequently, two devices can make use of that secret for authentication purposes as shown in the middle part of FIG. 6. After authentication, a node can check whether the other party has access rights, i.e. whether it is authorized, by checking its identity and corresponding access rights as shown in the bottom of FIG. 6. The confidentiality of communications can be ensured by using the generated secret to encrypt messages.

The security architecture, based on a single λ-secure key establishment method as shown in FIG. 6 has two main drawbacks. On the one hand, the capture of λ nodes leads to the compromise of the whole system. On the other hand, this approach requires the storage of a large amount of information regarding the access rights of each individual node in the network. Role based access control alternatives would reduce the storage requirements, but provide low flexibility due to the limited amount of roles that can be stored. For instance, a role based access control solution can be implemented by dividing the identifier space of the λ-secure key establishment method into several identifier sub-spaces. Each of these identifier sub-spaces is linked to a different role. In this manner, the role of a node can be identified easily by identifying the identifier sub-space which the nodes identifier belongs to. Relying on a centralized infrastructure for access control leads to increased delays and intensive traffic.

FIG. 12 shows a system according to a further embodiment which solves the beforehand mentioned limitations. The system comprises four features, namely multidimensional identification, authentication, access control and confidentiality protection. FIGS. 7 to 11 show the features of the system in detail.

FIGS. 7 and 8 are directed to the feature of the multidimensional identification or identity. The identity of any node, device or entity can be defined in general as a collection of features that can be described with an increasing degree of accuracy. For instance, in FIG. 7, the identity of an entity can be composed of N different features which may be listed in rows of a matrix. Each feature can be described with up to L different levels of precision which may be listed in columns of the matrix. The deeper the precision level, the more accurate the identity specification. FIG. 8, gives a possible example of this multidimensional identification model in which the location, ownership and role of an entity are described with different levels of precision.

In known systems based on λ-secure key establishment methods, a unique identifier is linked to each and every entity.

The multidimensional security architecture eliminates the unique identifier and substitutes it with a multidimensional identifier. This multidimensional identifier may comprise up to N different hierarchical sub-identifiers, each of them describing a feature of the entity. Additionally, each of these sub-identifiers may be built in a hierarchical manner and may consist of up to L elements, {IDᵢ₁, IDᵢ₂, . . . ID_{iL}}, so that each feature can be described with a varying level of precision. For instance, given a sub-identifier for feature i, {IDᵢ₁, IDᵢ₂, . . . ID_{iL}}, a sub-set of this sub-identifier, e.g., {IDᵢ₁, IDᵢ₂} describes the entity's feature partially, whereas the whole identifier {IDᵢ₁, IDᵢ₂, . . . ID_{iL}} describes the entity's feature fully. This approach has several advantages. For instance, an entity can disclose just a sub-set of its identity in order to protect its privacy sphere. FIG. 9 shows a node or entity which discloses the sub-identifiers ID11, ID21, IDn2, ID12.

FIG. 10 is directed to the feature of the multidimensional identification. The multidimensional security architecture allows authenticating each attribute or feature of the multidimensional identifier independently. This is advantageous compared to the traditional model in which the whole entity's identity is authenticated at once. For instance, it allows an entity to disclose just a part of its digital identity and authenticate just this part.

To this end, each sub-identifier of the entity's identity IDᵢⱼ, where i and j identify the feature and precision degree respectively, is linked to a set of λ-secure keying material KMᵢⱼ. In this manner, an entity can authenticate a specific feature by means of a particular keying material set as shown in FIG. 10. The hierarchical construction of the identifiers ensures that all sub-identifiers IDᵢⱼ with j<x are authenticated when a sub-identifier IDᵢₓ, with 1≦x≦L, is authenticated. In this manner, when an entity needs to authenticate that it has a feature IDᵢⱼ, it uses KMᵢⱼ to authenticate that feature.

FIG. 11 is directed to the feature of the multidimensional access control. An entity gets a specific set of rights in the system according to its identity, and more specifically, according to the features of its identity. For instance, an entity is allowed to access and modify the system, if and only if, that entity accomplishes a set of requirements.

In the multidimensional security architecture the entity's identity can be specified and authenticated according to a set of N features, each with up to L different degrees of precision. In this manner, the access to a resource can be restricted to entities with a specific profile, i.e., fulfilling a subset of features. FIG. 11 depicts a possible sub-set of features ID11, ID21, ID22, . . . IDn1, IDn2, IDnL which an entity has to fulfil in order to carry out an operation. In general, this procedure can be extended, so that different sub-sets of features enable different access rights.

The inventive system provides the feature of confidentiality protection. As depicted in FIG. 5, λ-secure key establishment methods allow two nodes carrying correlated keying material to agree on a common key. The multidimensional security architecture also allows a pair of nodes to agree on a common key with the difference that now each node carries several sets of keying material, so that a pair of nodes can make use of several sets of keying material to agree on a common key. Therefore, the key generation takes place in two steps. In a first step, each node generates a partial key Kⱼ for each feature j with 1≦j≦n. To this end, two nodes A and B discloses its hierarchical sub-identifier linked to that feature {ID₁ⱼ, ID₂ⱼ, . . . ID_{L}} with l≦L. Both nodes make use of their respective keying material (KMₗⱼ^{A}; and KMₗⱼ^{B}) and sub-identifiers (ID₁ⱼ^{A} and IDₗⱼ^{B}) to agree on a common key Kⱼ according to the rules of λ-secure key establishment method. This step is repeated n times, one per feature. In a second step, two nodes calculate a key K by combining the partial keys Kⱼ, with 1≦j≦n, generated by the keying material linked to each individual feature j. For instance, by calculating the XOR K=K₁ [symbol] K₂ [symbol] . . . [symbol] Kₙ of all keys.

FIG. 12 sketches and summarizes the multidimensional security architecture and its different components according to an embodiment of the invention. The first block “Identification” of the key distribution architecture represents all the identifiers that are used to characterize and identify an entity. In the second block “Authentication” the keying material that is linked to each and every of the corresponding entity's sub-identifiers is depicted. Each keying material sub-set is used to authenticate a sub-identifier. Finally, the third block “Authorization” depicts the minimal features that an entity must present in order to be allowed performing a certain action. In the process of authenticating a node, it is also possible to agree on a common key according to the feature of the confidentiality protection.

FIG. 13 shows an operation of a security architecture according to an embodiment of the invention. In particular FIG. 13 illustrates a practical application example of the use of the multidimensional security architecture to enable a lighting smart environment in which access control rights are taken into account. To this end, an office building as shown in FIG. 3 is assumed, i.e., users have different access rights depending on their location and role.

Three precision levels for the location feature are assumed, namely building, floor and room. In this context, a user, who is in her own office, shall have full control of her office lights. For instance, she might be able to set a rose tone in her office lights. The same user might have different, lesser access rights to the lighting system in her floor. For example, she can only switch on and off the lights and modify the light intensity level. Finally, the user has very restricted access rights when she is moving in other parts of the building.

Additionally, two different roles, a user and an administrator, are assumed. User's rights are limited to light control, while administrators are able, e.g., to set lighting operation in common rooms, such as meeting rooms, re-configure IDs of nodes, change keying material, add new nodes or upgrade nodes' firmware.

Two different types of nodes, lighting nodes like ballasts and control tokens are considered. A lighting node is a node that controls the lighting features in a specific location. Such nodes can be controlled according to user's preferences and their control is preconfigured so that only users with a specific set of features can carry out certain operations. Control tokens are carried by users and used to control the lighting system. A control token might be embodied in a mobile phone. A control token identifies the user who wants to access to the system.

According to previous assumptions, the operation of the system may comprise different phases. During a first setup phase, both lighting and control nodes are configured. Control nodes get keying material that identifies the features of the owner's control token, e.g., location, like building, floor or room and role, like administrator or normal user. Lighting nodes get a set of operation rules that specify which users have rights to carry out specific actions, and keying material used to authenticate the users. During a second phase, an operation phase, users or control tokens interact with the system, for example the lighting nodes. To this end, a user that wants to carry out a specific action has to be authenticated and authorized by the system. FIG. 13 shows a possible authorization handshake between user and system. In a first step (1), the user sends a configuration request to the system. The system checks what are the minimal requirements to carry out this action, i.e., what kind of individuals can perform that action. After this analysis, the system sends to the user an identification request (2). Finally, the user starts an authentication handshake to authenticate its identity features based on the system described in previous section (3). If the authentication process is successful, the system authorizes the configuration request from the user.

The system presents a nice feature as the user only discloses a part of its identity, so that the system also enables the protection of its identity. The inventive approach may find application in smart environment and control networks, such as IEEE 802.15.4/ZigBee® based networks. An application may be a distributed control system for ZigBee® Smart Environments. Additionally, the inventive approach can be applied to other networks, such as wireless sensor networks, in which basic security services must be provided in an ad hoc manner with a high security level and low resource requirements.

Features of the described embodiments may be combined or used in parallel when suitable.

At least some of the functionality of the invention may be performed by hard- or software. In case of an implementation in software, a single or multiple standard microprocessors or microcontrollers may be used to process a single or multiple algorithms implementing the invention.

It should be noted that the word “comprise” does not exclude other elements or steps, and that the word “a” or “an” does not exclude a plurality. Furthermore, any reference signs in the claims shall not be construed as limiting the scope of the invention

1. Node (100) for a network, comprising:
a first identifier (104) and first keying material (102);
means for authenticating (112) the first identifier based on the first keying material; and
means for checking (114) the access control rights of the node based on the first identifier and access rights corresponding to the first identifier in a distributed way.

2. Node according to claim 1, comprising means for agreeing (116) on a common secret between the node and a further node of the network, wherein the means for agreeing is configured to agree on the common secret based on the first identifier (104) and the first keying material (102) of the node and a second keying material and a second identifier of the further node.

3. Node according to claim 2, wherein the means for agreeing (116) is configured to agree on the common secret based on a λ-secure establishing method.

4. Node according to claim 3, wherein a role based access control solution is implemented by dividing the identifier space of the λ-secure key establishment method into several identifier sub-spaces, wherein each of these identifier sub-spaces is linked to a different role.

5. Node according to claim 2, wherein the means for authenticating (112) is configured to use the common secret for authenticating the first identifier (104).

6. Node according to claim 1, wherein the node comprises a plurality of features and each feature comprises a plurality of hierarchical levels, and wherein the first identifier (104) comprises a plurality of first sub-identifiers, wherein each hierarchical level of each feature is linked to a different one of the plurality of first sub-identifiers.

7. Node according to claim 6, wherein the first keying material (102) comprises a plurality of sets of first keying material, wherein each sub-identifier is linked to a different one of the plurality of sets of first keying material.

8. Node according to claim 7, wherein the means for authenticating (112) is configured to authenticate a particular first sub-identifier based on the set of first keying material linked to the particular first sub-identifier.

9. Node according to claim 8, wherein the means for authenticating (112) is configured to authenticate, additional to the particular first sub-identifier, all sub-identifiers being linked to a lower hierarchical level of the same feature the particular first sub-identifier is linked to.

10. Node according to claim 6, wherein the means for checking (114) is configured to check the authorization of the node based on the successful authentication of a set of first sub-identifiers and access rights corresponding to the set of first sub-identifiers.

11. Node according to claim 7, wherein the means for agreeing (116) is configured to agree on a common sub-secret for a particular sub-identifier based on the set of first keying material linked to the particular sub-identifier and a set of second keying material linked to a second sub-identifier of the further node.

12. Node according to claim 11, wherein the means for agreeing (116) is configured to generate a first partial key for the particular sub-identifier and to receive the second sub-identifier and a second partial key from the further node, for agreeing on the common sub-secret for the particular sub-identifier.

13. Node according to claim 11, wherein the means for agreeing (116) is configured to agree on a plurality of common sub-secret for a plurality of sub-identifiers and to determine a common secret based on the plurality of common sub-secrets.

14. Node according to claim 13, wherein the means for agreeing (116) is configured to determine the common secret by performing an XOR combination of the plurality of common sub-secrets.

15. Node according to claim 1, wherein the node is a lighting node (100a) of the network comprising a set of operation rules specifying access rights being required by the further node to carry out a specific action.

16. Node according to claim 1, wherein the node is a medical node used in a patient monitoring wireless sensor network.

17. Node according to claim 1, wherein the node is a control node (100d) of the network.

18. (canceled)

19. Method for establishing a security architecture for a network, comprising the steps of:
providing an identifier and keying material to a node of the network;
authenticating the identifier based on the keying material; and
checking the access control rights of the node in a distributed manner based on the identifier and access rights corresponding to the identifier.

20-21. (canceled)

22. A computer programmed to perform a method according to claim 19 and comprising an interface for communication with a lighting system.
